(19) United States
(12) Patent Application Publication
(10) Pub. No.: US 2010/0147128 A1
(43) Pub. Date: Jun. 17, 2010

(54) METHOD AND APPARATUS FOR SHEARING REINFORCED FABRICS

(76) Inventor: Richard David Vargo, Cuyaboga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/335,716

(22) Filed: Dec. 16, 2008

(51) Int. Cl. B23D 19/00

(52) U.S. Cl. 83/492

(57) ABSTRACT

A cutter apparatus for shearing a elastomeric material having large steel cords having a diameter in the range of 0.2 inches to about 0.3 inches is described. The cutter apparatus has: a first round blade rotatably mounted to a first hub, a second round blade rotatably mounted to a second hub, wherein the first and second hub are driven by a first and second motor, respectively; wherein the first and second blades are placed in parallel relationship with the centers of each blade being offset a distance d from each other.

### FIELD OF THE INVENTION

This invention relates to a method and apparatus for cutting or shearing fabrics, and more particularly to the shearing of steel reinforced fabrics.

### BACKGROUND OF THE INVENTION

Tire belt stock, particularly for medium radial truck tires and off the road tires, comprises large steel reinforcements coated with rubber. The shearing mechanics of large diameter wire is considerably different than the shearing mechanics of passenger belt wire. Truck tire belt and off the road belts have much larger wire with a greater number of filaments than passenger belts, requiring more energy to shear. As the angle of the cut decreases, more energy is required to make the cut. In addition, as the angle decreases, the wire may move during the cut, resulting in wire ends that are non-uniform with scalloped ends or have dog ears.

One type of prior art shearing device used to cut tire belt stock is the alpha shear, similar to a pair of scissors. The alpha shear, as shown in FIG. 1, has one moving blade which is pivoted about the anvil, coming into engagement with the anvil in order to make the cut. The disadvantage to this type of shear is that the rake angle decreases during the cut, the energy required to make the cut increases as the cut progresses. Another type of prior art cutting device is shown in FIG. 2. This guillotine style of shear also has a fixed anvil wherein the blade is brought straight down in a guillotine fashion. The disadvantage to this type of shear is that the blade has a very small rake angle which means the cut is made through the material all at once, which requires a large amount of energy, and thus requires a massive reinforced machine. A third type of prior art device is shown in FIG. 3. This type of shear has a round blade that rolls at a speed slightly faster than the horizontal travel of the cutter. The material being cut is stationary, while the blade rolls across the anvil. While this type of shear is an improvement compared to the previous styles of shears, it still has a comparatively high rake angle, resulting in a high amount of force required to make the cut.

Thus it is desired to having a cutting device with improved shearing mechanics which can cut through the reinforcements resulting in a smooth even cut with minimal fraying of the belt wire ends. A further objective is to cut the treatment with no damage or bending resulting in a smooth cut. A smooth cut results in the least amount of energy being expended and higher quality product produced from the cut. If the cutting force is minimized, then the blade wear is also minimized.

### SUMMARY OF THE INVENTION

A cutter apparatus is provided having a first round blade rotatably mounted to a first hub, a second round blade rotatably mounted to a second hub. The first and second hub are driven by a first and second motor, respectively; wherein the first and second blades are placed in parallel relationship with the centers of each blade being offset a distance d from each other.

### DEFINITIONS

“Cut belt” or “cut breaker reinforcing structure” means at least two cut layers of plies of parallel cords, woven or unwoven, underlying the tread, unanchored to the bead, and having both left and right cord angles in the range from 5 degrees to 90 degrees with respect to the equatorial plane of the tire.

“Cord” means one of the reinforcement strands of which the plies in the tire are comprised.

“Ply” means a continuous layer of rubber-coated parallel cords.

“rake angle” means the angle between the blade and the anvil at the point of cutting;

### BRIEF DESCRIPTION OF THE DRAWINGS

FIGS. 1 -3 are schematic views of prior art cutting mechanisms;

FIG. 4 illustrates a front view of a cutter mechanism of the invention;

FIG. 5 illustrates a side view of the cutter mechanism of FIG. 4;

FIG. 6 illustrates the geometrical relationships of the cutter mechanism of FIG. 4; and

FIG. 7 illustrates the effect of rake angle as a function of anvil diameter and overlap of blade and anvil.

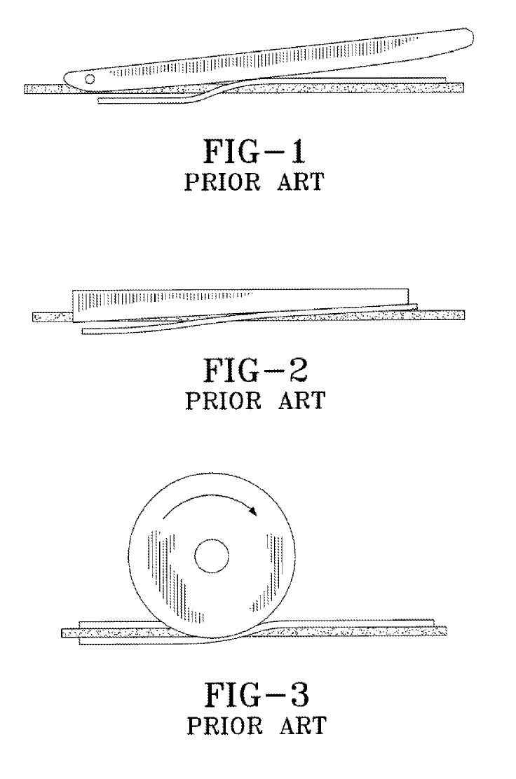

### DETAILED DESCRIPTION OF AN EXAMPLE EMBODIMENT THE INVENTION

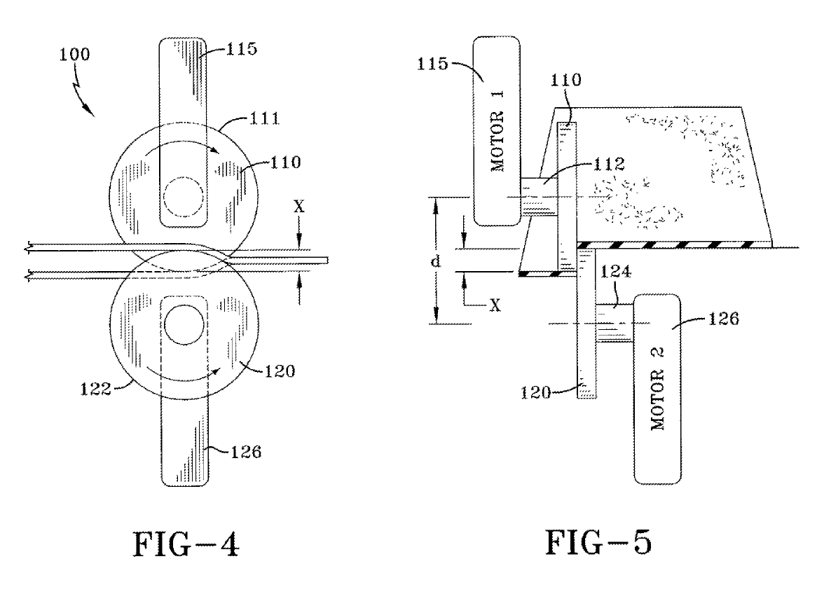

FIGS. 4 and 5 illustrate a cutter mechanism 100 of the present invention, useful for cutting reinforced ply, particularly ply with steel or metal reinforcements having a large diameter. As shown in FIG. 4, the cutter mechanism 100 includes a first blade 110 rotatably mounted to a hub support 112. The first blade 110 is preferably round in shape and having a smooth, non-serrated circumferential outer edge 111. The hub support 112 is connected to a first motor 115 for driving the round blade 110 during the cutting operation. The cutter mechanism further comprises a second blade 120 which is preferably round in shape and has a smooth, non-serrated outer circumferential edge 122. The second blade is mounted to a hub support 124, that is rotatably mounted, and driven by a second motor 126.

The second blade 120 is positioned relative to the first blade so that the plane of the blades are parallel to each other and closely spaced apart, with the centers of the blades being offset from each other a distance d. Preferably, the circumferential edges of the blades overlap slightly a distance X, wherein X is the interference overlap. The interference overlap X may range from about 0.1 inch to about 1 inch, and more preferably from about 0.2 inch to about 0.5 inch.

The material stock to be cut comprises rubber or elastomeric stock with parallel reinforcements embedded in the elastomer. The reinforcements may be steel or metal and be quite large, having a diameter that may be greater than 0.3 inches. The plane of the material stock is fed between the blades, at 90 degrees orientation relative to the plane of the blades. The material stock is typically rubber stock with large steel reinforcements that are closely spaced in parallel relation. The blades cut across the reinforcements at an angle which may range from about 5 to about 90 degrees. The material stock is conveyed or fed into the nip between the two rotating blades. As the blades rotate the cut is made, splitting the material in half. A first cut portion passes over the blade, and a second cut portion passes below the blade. The upper blade functions as the blade performing the cut, while the lower blade functions as the anvil. The first blade rotates at a first speed, while the second blade rotates at a second speed. Preferably, the blades rotate at about the same speed.

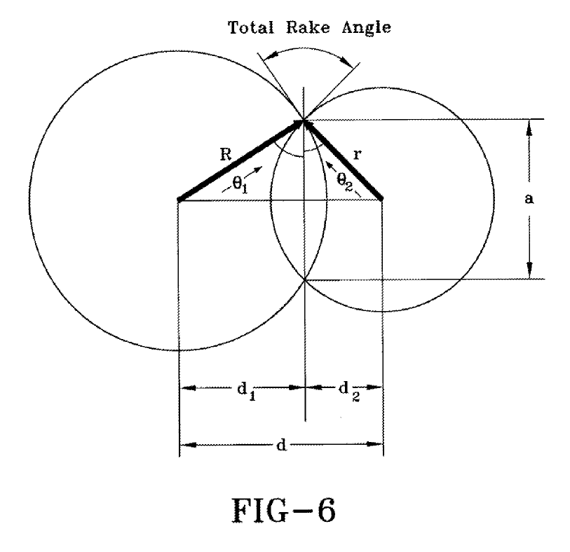

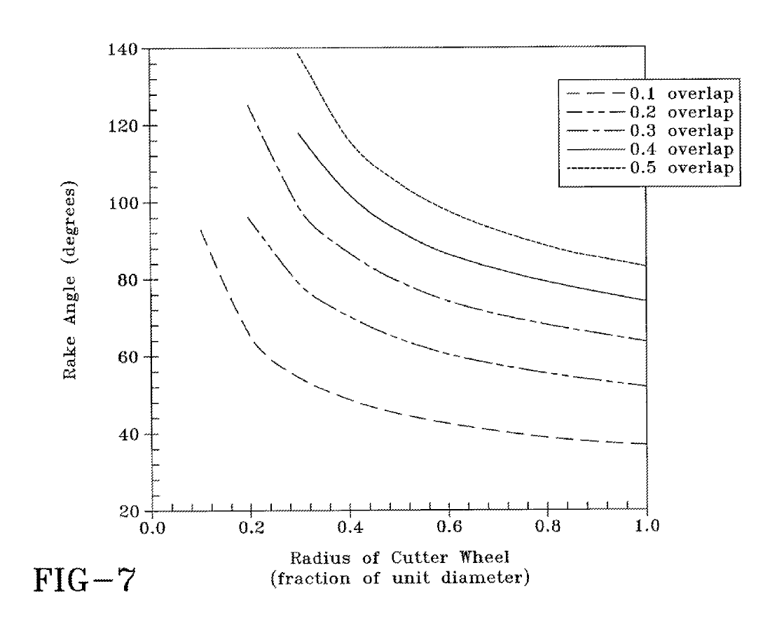

FIG. 6 illustrates the geometry of the cutting device. Note the total rake angle shown in the figure as well as the blade overlap. As shown in FIG. 7, changing the interference overlap of the blades has a greater impact on the rake angle than changing the diameter of the cutter by the same proportion. FIG. 7 illustrates that the rake angle decreases as the amount of overlap increases.

It is desired to maximize the rake angle of the system because larger rake angles result in less material being cut at a given time, which decreases the energy required to perform the cut. Thus it is preferred that the blades overlap in the range of about 0.1 inch to about 0.5 inches. Alternatively, one blade may be in the range of about 10% to about 90% the size of the other blade, more preferably in the range of about 20% to about 40% the size of the other blade. On order to maximize the rake angle, it is desired to maximize the amount of overlap and to make one blade much bigger than the other blade.

For purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A cutter apparatus for shearing a elastomeric material having large steel cords having a diameter in the range of 0.2 inches to about 0.3 inches, the cutter apparatus comprising: a first round blade rotatably mounted to a first hub, a second round blade rotatably mounted to a second hub, wherein the first and second hub are driven by a first and second motor, respectively; wherein the first and second blades are placed in parallel relationship with the centers of each blade being offset a distance d from each other.

2. The cutter apparatus of claim 1 wherein the blades rotate at about the same speed.

3. The cutter apparatus of claim 1 wherein one of the blades is larger than the other blade.

4. The cutter apparatus of claim 1 wherein the ratio R/r ranges from about 0.1 to about 1, wherein r is a first blade radius, and R is a second blade radius.

5. The cutter apparatus of claim 1 wherein the blades have an overlap distance X in the range from about 0.05 to about 1 inch.
